(19) United States
(12) Patent Application Publication
(10) Pub. No.: US 2004/0101657 A1
(43) Pub. Date: May 27, 2004

(54) Method of microfluidic construction using composite polymer films

(76) Inventor: Donald R. Moles, Cedarville, OH (US)

Correspondence Address: THOMPSON HINE L.L.P., 2000 COURTHOUSE PLAZA , N.E., 10 WEST SECOND STREET, DAYTON, OH, 45402, US

(21) Appl. No.: 10/642,114

(22) Filed: Aug. 15, 2003

Related U.S. Application Data
(60) Provisional application No. 60/404,297, filed on Aug. 19, 2002.

(51) Int. Cl. B32B 3/00

(52) U.S. Cl. 428/166

(57) ABSTRACT

A microfluidic device comprising a first polyimide film having at least one microfeature formed in at least one surface thereof, and a second polyimide film adjacent the surface of the first polyimide film containing the microfeatures, a bonding layer between the first polyimide film and the second polyimide film, the bonding layer being a layer of a thermoplastic fluoropolymer.

### CROSS REFERENCE TO RELATED APPLICATIONS

This invention claims priority from U.S. Provisional Application No. 60/404,297 filed on Aug. 19, 2002.

### BACKGROUND OF THE INVENTION

In the field of microfluidics it is desirable to create structures, which can contain and conduct fluids in small channels and cavities. One approach to the fabrication of these types of devices involves the use of films. It has been previously demonstrated that micro-scale features can be etched into the surfaces of polymeric films. Various chemical etching and laser ablation processes exist, which can create features on the scale of microns. However, in order to utilize these capabilities in the fabrication of fluidic devices, the features must be encapsulated. Closing of the featured surface has proven itself to be problematic. An approach, defined in this application, suggests the utilization of composite films to accomplish this goal.

Polyimide films, such as those manufactured by DuPont or UBE, range in thickness from approximately 0.5 to 6 mils. These films exhibit many desirable characteristics, which make them suitable substrates for the fabrication of microfluidic devices. In addition to the inherent chemical inertness and physical stability of these materials, they also can be patterned using standard lithographic processes in conjunction with wet or dry etching techniques. They also strongly absorb light in the UV region, which makes them ablate easily and cleanly using certain laser ablation systems, which emit in that spectra.

When considering methods for sealing the surface features created by these techniques, it is paramount that the desirable characteristics of the substrate material, not be compromised by the closure material. This is especially important in cases where the microfluidic may be used as part of an analytical system, such as a clinical diagnostic device. Adhesives, in general, usually have some characteristic which limits their use in microfluidic systems. Most adhesives have not been designed for use in situations where the adhesive will come into contact with reagents, which might be affected. Adhesives, also are too mobile during lamination and may fill small structures which may be on the substrate film surfaces.

This application describes a technique whereby certain composite films may be used to encapsulate surface features without compromising the chemical inertness or physical integrity of the fabricated device.

### BRIEF DESCRIPTION OF DRAWINGS

FIGS. 1-6 are cross sections of microfluidic devices in accordance with different embodiments of the invention. In each instance the drawing on the left of the figure shows the individual elements forming the device and the drawing on the right of the figure shows the laminated device.

### DESCRIPTION OF THE INVENTION

Various forms of fluoropolymer, e.g. polytetrafluorethylene (PTFE), Fluorinated Ethylene Propylene (FEP), Perfluoroalkoxy PFA etc., have been available for many years. It is known that these compounds are very inert, chemically. It is also known that these compounds can form a “heat seal” when bonded as a film against itself or other surfaces. This sealing is accomplished at temperatures around 350° C. under modest pressure (e.g., 15-30 psi). A heated vacuum press can be used. Although most of these heat-sealing applications are usually confined to strips at the edge of a bag, or other container, the same adhesion can be obtained over large areas under similar conditions. Furthermore, the quality of the adhesion appears to be independent of the thickness of the fluoropolymer layer in situations where the substrate being bonded has very smooth surfaces. Consequently, it is possible to bond two flat surfaces with an extremely thin layer of fluoropolymer at the interface, provided that the lamination fixturing is also adequately smooth and flat.

Several FEP-Polyimide composite films are available commercially. Examples of these are the “FN” and “Oasis” series of products offered by Dupont. The minimum FEP thickness available is 2.5 microns. This thickness is available only on a 25 micron thick polyimide substrate. This product seals well against other polyimide films, including those films which have been etched in order to create three dimensional surface features. At this thickness of FEP there is some minimal extrusion of FEP into the encapsulated volume. This degree of extrusion is acceptable for encapsulated structures larger than, approximately, 50 microns. For smaller structures, a thinner layer of FEP is probably needed.

Another difficulty in using the off-the-shelf composites is that the side of the composite containing the fluoropolymer is difficult to chemically etch due to its inertness. This may be overcome through the use of non-wet chemistry techniques of etching, e.g. laser ablation or ion milling. This allows for the closure side of the laminate to also contain three-dimensional surface features.

An approach, which overcomes most of these limitations, involves coating the etched polyimide with a very thin layer of fluoropolymer after the features have been created. This has several favorable characteristics associated with it. First, the thickness of the FEP layer can be tightly controlled, thereby, limiting the extrusion effects of lamination. Secondly, this creates a uniform material inside the internal encapsulated cavity, simplifying surface chemistry effects. Thirdly, this techniques allows for the use of relative inexpensive non-composite forms of commercially available polyimide film.

Thin coating of Teflon™-like thin films can be deposited using chemical vapor desposition (CVD). Several techniques appear in the literature. Some techniques utilize thermal decomposition of fluorocarbon pre-cursors, i.e. pyrolytic processes, while other techniques rely upon plasma to generate the reactive pre-cursors, as in plasma enhanced chemical vapor desposition (PECVD). In either case, Teflon™-like layers can be generated of suitable thickness, in the range of a micron, or so.

Three methods of microfluidic construction are envisioned within the scope of this application. All of these methods incorporate at least one etched polyimide film which, has been laminated using some form of fluoropolymer as the interfacial sealing agent. The range of fluoropolymer appropriate for this purpose will range from 10 microns down to 100 angstroms, with the preferred thickness being in the range of 0.5 to 1.5 microns.

FIG. 1 illustrates one embodiment of the invention in which the microfluidic is formed from a first polyimide 10 and a second polyimide film 12 having a surface layer 14 of a fluoropolymer. In this embodiment of the invention the polyimide film 10 includes a microchannel 20. Using heat and pressure, the film 10 is laminated to the opposing film 12 with the intervening fluoropolymer layer between.

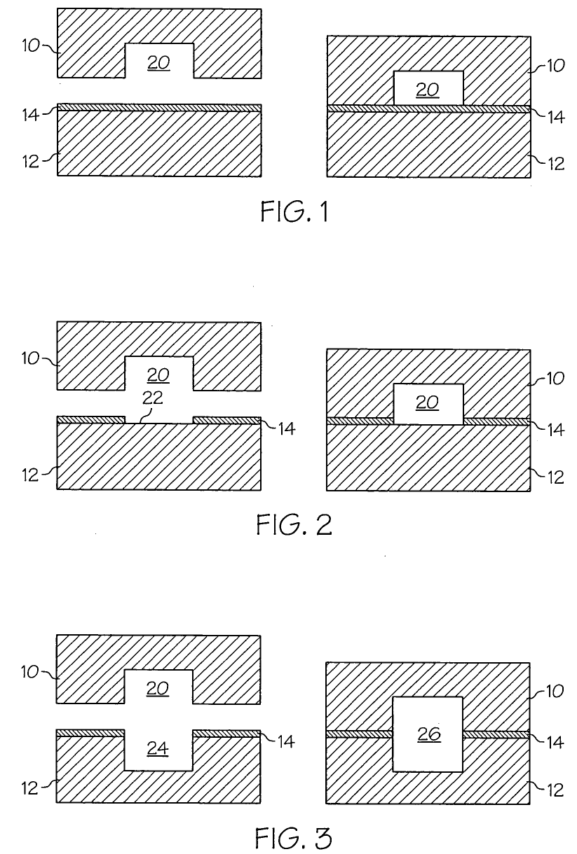

FIG. 2 illustrates a further embodiment of the invention in which the polyimide layer 10 includes a microchannel 20 and the polyimide film 12 is coated with a layer 14 of a fluoropolymer but the fluoropolymer has been removed in the area 22 corresponding to the microchannel 20. Using heat and pressure, film 10 is laminated to film 12 with the fluoropolymer 14 bonding the two films together. In this device, unlike the device shown in FIG. 1, the major surfaces of the microchannel 20 are formed from the same polymer, i.e., polyimide.

FIG. 3 illustrates a further embodiment of the invention in which the polyimide film 10 having the microchannel 20 is bonded to a polyimide film 12 which also includes a corresponding channel 24. The film 12 is coated with a fluoropolymer 14. When the two films are laminated together, the structure shown in the right hand of FIG. 3 is obtained in which the microchannels 20 and 24 align to form the larger channel 26. The fluoropolymer layer 14 bonds the two films together.

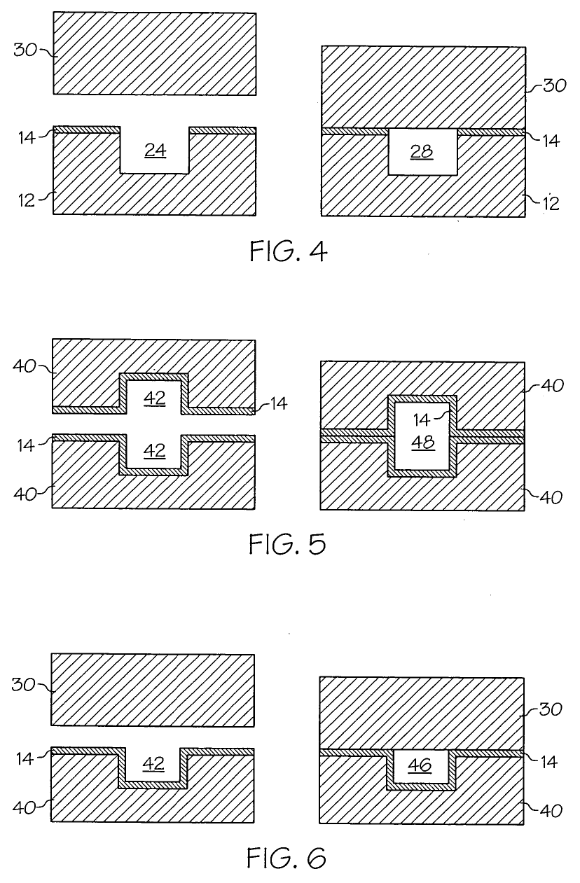

FIG. 4 illustrates an embodiment of the invention in which the polyimide film 30 does not include a microchannel or the film 30 includes a channel but not in the vicinity of the channel in the opposing film. The film 12 includes a channel 24 and is coated with fluoropolymer 14. When film 30 is laminated to film 12, a structure analogous to that shown in FIG. 1 is obtained in which the major surfaces of the enclosed channel 28 are formed from polyimide.

FIG. 5 illustrates still a further embodiment of the invention in which a film 40 including a channel 42 and a fluoropolymer layer 14 is bonded to an opposing film 40 including a corresponding channel 42 and fluoropolymer layer 14. In the laminated film, the channel 48 formed by combining the subchannels 42 has all of its major surfaces coated with the fluoropolymer 14.

FIG. 6 illustrates still another embodiment of the invention in which a polyimide film 30 is bonded to a film 40 including a channel 42 and a layer of a fluoropolymer 14. When laminated by heat and pressure, the channel 46 in the film 40 is covered by the film 30.

Having described the invention in detail and by reference to specific embodiments thereof, it will be apparent that various modifications and changes can be made herein without departing from the spirit and scope of the invention as defined by the following claims:

What is claimed is:

1. A microfluidic device comprising a first polyimide film having at least one microfeature formed in at least one surface thereof, and
a second polyimide film adjacent the surface of the first polyimide film containing the microfeatures,
a bonding layer between the first polyimide film and the second polyimide film, the bonding layer being a layer of a thermoplastic fluoropolymer.

2. The microfluidic device of claim 1 wherein the bonding layer is not present in the areas defined by the microfeature.

3. The microfluidic device of claim 1 wherein the second polyimide film also includes at least one microfeature on at least one surface thereof.

4. The method of claim 3 wherein at least one microfeature in the first polyimide film corresponds to at least one microfeature in the second polyimide film such that the microfeatures cooperate to form a single microfluidic element.

5. A method for forming a microfluidic device which comprises:
providing a first polyimide film,
providing a second polyimide film having a layer of a fluoropolymer on the surface thereof, at least one of the first polyimide film and the second polyimide film having at least one microfeature formed in at least one surface thereof, and
laminating the first polyimide film with the second polyimide film such that the microfeature in the first polyimide film is covered by the opposing polyimide film by applying heat and pressure.

6. The method of claim 5 wherein the fluoropolymer bonding layer is not present in the areas corresponding to the microfeature.

7. The method of claim 6 wherein both the first polyimide film and the second polyimide film includes a microfeature in the surface thereof.

8. The method of claim 5 wherein the first polyimide film has a microfeature formed on at least one surface thereof bonding layer of a thermoplastic fluoropolymer on that surface.

9. The method of claim 8 wherein the second polyimide film additionally includes a bonding layer of a thermoplastic fluoropolymer.

10. The method of claim 9 wherein the second polyimide film additionally includes a microfeature in at least one surface thereof.
